(19) United States
(12) Patent Application Publication
(10) Pub. No.: US 2014/0250091 A1
(43) Pub. Date: Sep. 4, 2014

(54) Systems and Methods for Managing Media Files

(71) Applicant: Cyberlink Corp., Shindian City (TW)

(72) Inventor: Huang-Hsin Wu, New Taipei City (TW)

(73) Assignee: Cyberlink Corp., Shindian City (TW)

(21) Appl. No.: 13/955,128

(22) Filed: Jul. 31, 2013

Related U.S. Application Data
(60) Provisional application No. 61/772,100, filed on Mar. 4, 2013.

(51) Int. Cl. G06F 17/30

(52) U.S. Cl. CPC G06F 17/30115
USPC 707/694

(57) ABSTRACT

Various embodiments are disclosed for facilitating media management. A method for managing digital content comprises obtaining a media file and generating a primary identifier unique to the media file and obtaining at least one storage destination for the media file, wherein the at least one storage destination comprises one of: at least one user-specified storage destination and at least one storage destination automatically determined by an analyzing component. Based on the at least one storage destination, a secondary identifier unique to the at least one storage destination is generated. The method further comprises generating a media identifier based on primary identifier and the secondary identifier, storing the media identifier, and performing batch processing of media files based on corresponding media identifiers.

### CROSS-REFERENCE TO RELATED APPLICATION

This application claims priority to, and the benefit of, U.S. Provisional Patent Application entitled, “Systems and Methods for Managing Media Files,” having Ser. No. 61/772,100, filed on Mar. 4, 2013, which is incorporated by reference in its entirety.

### BACKGROUND

With the ever-growing amount of digital content available to consumers through the Internet and other sources, consumers have access to a vast amount of content. Furthermore, many mobile devices allow consumers to capture digital images. With the widespread use of digital cameras and other devices, many individuals turn to image management tools to archive and organize their media files. While many image management tools are readily available, the management process can still be tedious and time-consuming when managing a large volume of files.

### SUMMARY

Briefly described, one embodiment, among others, is a method for managing digital content. The method comprises obtaining a media file and generating a primary identifier unique to the media file and obtaining at least one storage destination for the media file, wherein the at least one storage destination comprises one of: at least one user-specified storage destination and at least one storage destination automatically determined by an analyzing component. Based on the at least one storage destination, a secondary identifier unique to the at least one storage destination is generated. The method further comprises generating a media identifier associated with the media file based on the primary identifier and the secondary identifier, storing the media identifier, and performing batch processing of media files based on corresponding media identifiers.

Another embodiment is a system for managing digital content that comprises a media interface configured to obtain a media file and an analyzing component configured to analyze at least one storage destination for the media file. The system further comprises a media identifier (ID) generator configured to generate a primary identifier unique to the media file, generate a secondary identifier unique to the at least one storage destination, generate a media identifier associated with the media file based on the primary identifier and the secondary identifier, and store the media identifier on a network storage device. The system further comprises a batch processor configured to perform batch processing of media files based on corresponding media identifiers.

Another embodiments is a non-transitory computer-readable medium embodying a program executable in a computing device that comprises code that obtains a media file and generating a primary identifier unique to the media file based on at least one attribute of the media file, code that obtains user input specifying at least one storage destination for the media file, code that generates a secondary identifier based on the specified at least one storage destination, and code that generates a media identifier associated with the media file based on the primary identifier and the secondary identifier.

The program further comprises code that stores the media identifier in a network storage device, code that renders for display a user interface presenting media files and corresponding storage destinations based on corresponding media identifiers, code that obtains a command from a user relating to at least one media file presented on the user interface, and code that applies the command to each copy of the media file stored in the corresponding storage destinations according to the corresponding media identifiers.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a block diagram of a media management system for facilitating digital content management in accordance with various embodiments of the present disclosure.

FIG. 1B illustrates various components of the media processor in the media management system of FIG. 1A in accordance with various embodiments of the present disclosure.

FIG. 2 is a detailed view of the media management system of FIG. 1A in accordance with various embodiments of the present disclosure.

FIG. 3 is a top-level flowchart illustrating examples of functionality implemented as portions of the media management system of FIG. 1 for facilitating digital content management according to various embodiments of the present disclosure.

FIGS. 4-7 illustrate the operation of various components of the media management system of FIG. 1A in accordance with various embodiments of the present disclosure.

### DETAILED DESCRIPTION

One perceived shortcoming with conventional image editing applications is the amount of time involved in selecting images for editing purposes. With many applications, users manually identify individuals or objects of interest within digital images and apply a special effect or editing operation to the digital image. While some image editing applications perform automatic facial detection, the editing process can still be time-consuming, particularly when the user wishes to organize and search through a large volume of images.

In many cases, an individual may wish to apply the same editing operation to all copies of a particular digital image that is stored in multiple storage destinations. For example, some digital images may be stored on an external hard drive, a smartphone, a tablet, a laptop, and/or cloud storage. In such instances, organizing and editing photos can be even more time-consuming, especially when the individual wishes to apply the same modification to copies of the same digital photo stored in multiple storage destinations.

Various embodiments are described for facilitating digital content management by reducing the time and effort involved in editing digital images. Note that while various systems and methods are described in the context of digital photos, it should be emphasized that the techniques may also be applied to digital content in general such as video and audio content. One embodiment, among others, is directed to a method for managing multimedia content. In accordance with some embodiments, a method comprises obtaining a media file and generating a primary identifier unique to the media file.

The method further comprises obtaining user input specifying a storage destination for the media file. Based on the specified storage destination, a secondary identifier is generated. A media identifier is generated based on the primary identifier and the secondary identifier. The method further comprises storing the media identifier and performing batch processing of media files based on corresponding media identifiers.

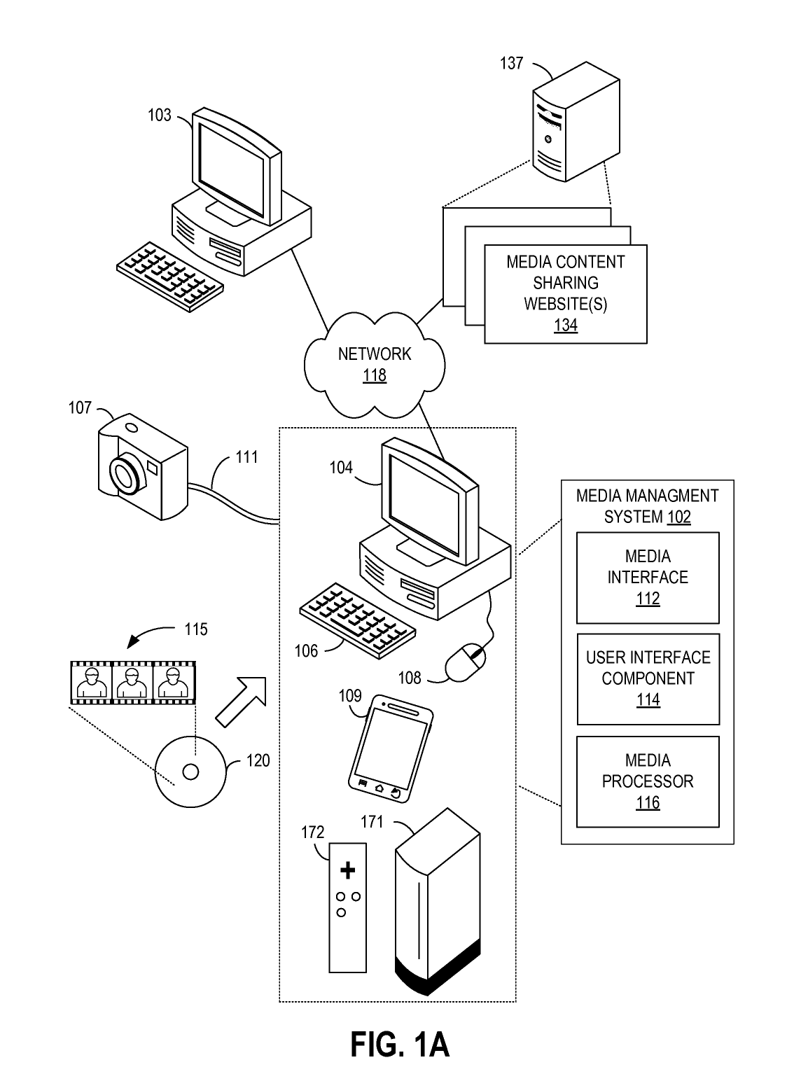

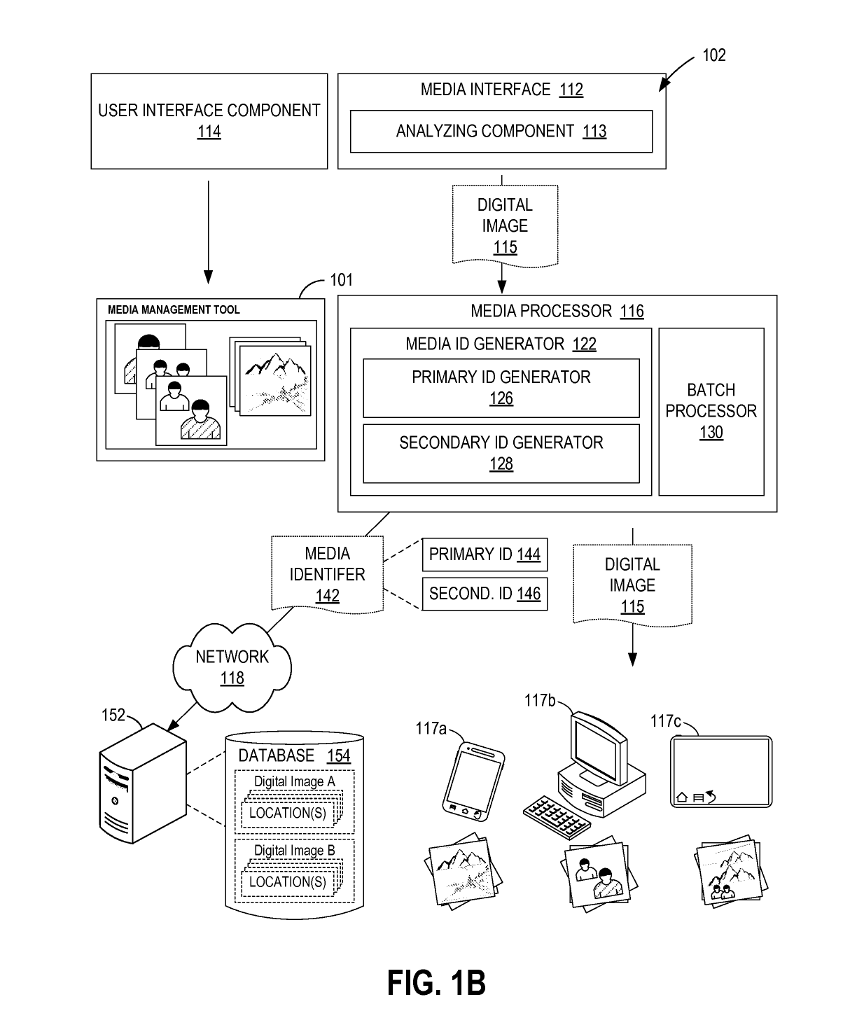

A description of a system for facilitating digital content management is now described followed by a discussion of the operation of the components within the system. FIG. 1A is a block diagram of a media management system 102 in which embodiments of the digital content management techniques disclosed herein may be implemented. The media management system 102 may be embodied, for example, as a desktop computer, computer workstation, laptop, a smartphone 109, a tablet, or other computing platform that includes a display 104 and may include such input devices as a keyboard 106 and a mouse 108.

For embodiments where the media management system 102 is embodied as a smartphone 109 or tablet, the user may interface with the media management system 102 via a touchscreen interface (not shown). In other embodiments, the media management system 102 may be embodied as a video gaming console 171, which includes a video game controller 172 for receiving user preferences. For such embodiments, the video gaming console 171 may be connected to a television (not shown) or other display 104.

The media management system 102 is configured to retrieve, via the media interface 112, digital media content 115 stored on a storage medium 120 such as, by way of example and without limitation, a compact disc (CD) or a universal serial bus (USB) flash drive, wherein the digital media content 115 may then be stored locally on a hard drive of the media management system 102. As one of ordinary skill will appreciate, the digital media content 115 may be encoded in any of a number of formats including, but not limited to, JPEG (Joint Photographic Experts Group) files, TIFF (Tagged Image File Format) files, PNG (Portable Network Graphics) files, GIF (Graphics Interchange Format) files, BMP (bitmap) files or any number of other digital formats.

As depicted in FIG. 1A, the media interface 112 in the media management system 102 may also be configured to retrieve digital media content 115 directly from a digital camera 107 where a cable 111 or some other interface may be used for coupling the digital camera 107 to the media management system 102. The media management system 102 may support any one of a number of common computer interfaces, such as, but not limited to IEEE-1394 High Performance Serial Bus (Firewire), USB, a serial connection, and a parallel connection.

The digital camera 107 may also be coupled to the media management system 102 over a wireless connection or other communication path. The media management system 102 may be coupled to a network 118 such as, for example, the Internet, intranets, extranets, wide area networks (WANs), local area networks (LANs), wired networks, wireless networks, or other suitable networks, etc., or any combination of two or more such networks. Through the network 118, the media management system 102 may receive digital media content 115 from another computing system 103. Alternatively, the media management system 102 may access one or more media content sharing websites 134 hosted on a server 137 via the network 118 to retrieve digital media content 115.

The user interface component 114 in the media management system 102 is configured to generate a user interface rendered for display to a user of the media management system 102 for obtaining one or more storage destinations for digital content 115 obtained via the media management system 102. The user input may also comprise one or more batch processing operations, as described in more detail below.

The media processor 116 is configured to calculate a primary identifier and a secondary identifier for each media file, where the primary identifier is unique to the media file and is generated according to one or more attributes of the media file. The secondary identifier is generated by the media processor 116 according to the storage destination specified for the media file. A media identifier comprising the primary identifier and the secondary identifier is generated.

A user may then systematically organize and edit media content according to media identifiers assigned to each of the media files. The media processor 116 may be configured to perform, for example, batch processing on all copies of the same media file where the copies are distributed across different storage destinations (e.g., external hard drive, cloud-based storage).

Reference is made to FIG. 1B, which illustrates various components of the media processor 116 in FIG. 1A. As shown, the media processor 116 further comprises a media ID generator 122, which further comprises a primary identifier (ID) generator 126 and a secondary identifier (ID) generator 128. The media processor 116 also includes a batch processor 130. As discussed above, the media management system 102 comprises an analyzing component 113 configured to analyze and obtain one or more storage destinations 117a, 117b, 117c for digital content 115. Each of the storage destinations 117a, 117b, 117c represent different storage devices with computing capabilities such as a desktop, PC, tablet, a mobile device, and so on.

Note that one or more of the storage device 117a, 117b, 117c may comprise a media management system 102. In implementations where only one of storage devices (e.g., device 117a) is embodied as a media management system 102 and where the other two storage devices 117b, 117c do not have computing capabilities, the storage device 117a may query the other two storage devices 117b, 117c to obtain information relating to their corresponding storage destinations via the network 118. In alternative embodiments, the storage destinations for each media file may also be input or specified by a user. The media ID generator 122 is configured to receive imported digital images 115 and assign media identifiers 142 that comprise a primary identifier 144 and a secondary identifier 146. The media ID generator 122 generates a media identifier 142 associated with the media file based on the primary identifier 144 and the secondary identifier 146.

In accordance with some embodiments, the primary ID generator 126 may be configured to generate the primary identifier 144 according to the MD5 (Message-Digest) algorithm, which is a cryptographic hash function that produces a 128-bit hash value. In accordance with other embodiments, the primary ID generator 126 may be configured to generate the primary identifier 144 according to a 32-bit Cyclic Redundancy Check (CRC) or 64-bit CRC of the digital image 115. For some embodiments, the primary ID generator 126 may be configured to generate the primary identifier 144 according to the color distribution of the digital image 115 and/or Exchangeable Image File Format (EXIF) data corresponding to of the content of the digital image 115.

The secondary ID generator 128 is configured to generate a secondary ID 146 according to the storage device/destination 117a, 117b, 117c specified by the user for the imported digital image 115. Thus, in some instances, copies of the same digital image 115 might share the same primary identifier 144 but have different secondary identifiers 146. For some embodiments, the media identifiers 142 derived by the media ID generator 122 are uploaded via the network 118 to a media management server 152 or other network storage device, which maintains a database 154 based on the media identifiers 142. The database may contain such information as the storage location(s) of a given media file and may be representative of a plurality of databases as can be appreciated. The data stored in the database 154, for example, is associated with the operation of the various applications and/or functional entities described herein.

The batch processor 130 in the media processor 116 is configured to allow the user to systematically organize and/or edit digital images 115 according to their corresponding media identifiers 142. For example, by utilizing the media management system 102, a user may apply a file name change to every copy of the same digital image 115, regardless of whether the copies are stored in one location or across multiple storage locations. In the illustration of FIG. 1B, each of the storage destinations 117a, 117b, 117c stores a collection of digital images 115. Other batch processing operations comprise copying, renaming, and so on.

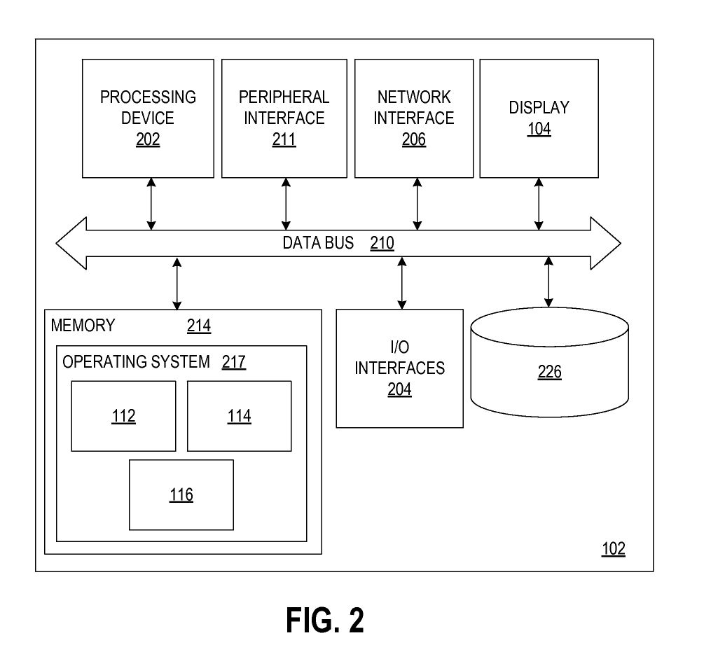

FIG. 2 is a schematic diagram of the media management system 102 shown in FIG. 1A. The media management system 102 may be embodied in any one of a wide variety of wired and/or wireless computing devices, such as a desktop computer, portable computer, dedicated server computer, multiprocessor computing device, smartphone 109 (FIG. 1A), tablet computing device, and so forth. As shown in FIG. 2, the media management system 102 comprises memory 214, a processing device 202, a number of input/output interfaces 204, a network interface 206, a display 104, a peripheral interface 211, and mass storage 226, wherein each of these devices are connected across a local data bus 210.

The processing device 202 may include any custom made or commercially available processor, a central processing unit (CPU) or an auxiliary processor among several processors associated with the media management system 102, a semiconductor based microprocessor (in the form of a microchip), a macroprocessor, one or more application specific integrated circuits (ASICs), a plurality of suitably configured digital logic gates, and other well known electrical configurations comprising discrete elements both individually and in various combinations to coordinate the overall operation of the computing system.

The memory 214 can include any one of a combination of volatile memory elements (e.g., random-access memory (RAM, such as DRAM, and SRAM, etc.)) and nonvolatile memory elements (e.g., ROM, hard drive, tape, CDROM, etc.). The memory 214 typically comprises a native operating system 217, one or more native applications, emulation systems, or emulated applications for any of a variety of operating systems and/or emulated hardware platforms, emulated operating systems, etc.

The applications may include application specific software which may comprise some or all the components (media interface 112, user interface component 114, media processor 116) of the media management system 102 depicted in FIG. 1A. In accordance with such embodiments, the components are stored in memory 214 and executed by the processing device 202. One of ordinary skill in the art will appreciate that the memory 214 can, and typically will, comprise other components which have been omitted for purposes of brevity.

In this regard, the term “executable” may refer to a program file that is in a form that can ultimately be run by the processing device 202. Examples of executable programs may be, for example, a compiled program that can be translated into machine code in a format that can be loaded into a random access portion of the memory 214 and run by the processing device 202, source code that may be expressed in proper format such as object code that is capable of being loaded into a random access portion of the memory 214 and executed by the processing device 202, or source code that may be interpreted by another executable program to generate instructions in a random access portion of the memory 214 to be executed by the processing device 202, etc. An executable program may be stored in any portion or component of the memory 214 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

Input/output interfaces 204 provide any number of interfaces for the input and output of data. For example, where the media management system 102 comprises a personal computer, these components may interface with one or more user input devices via the I/O interfaces 204, where the user input devices may comprise a keyboard 106 (FIG. 1A) or a mouse 108 (FIG. 1A). The display 104 may comprise a computer monitor, a plasma screen for a PC, a liquid crystal display (LCD), a touchscreen display, or other display device 104.

In the context of this disclosure, a non-transitory computer-readable medium stores programs for use by or in connection with an instruction execution system, apparatus, or device. More specific examples of a computer-readable medium may include by way of example and without limitation: a portable computer diskette, a random access memory (RAM), a read-only memory (ROM), an erasable programmable read-only memory (EPROM, EEPROM, or Flash memory), and a portable compact disc read-only memory (CDROM) (optical).

With further reference to FIG. 2, network interface 206 comprises various components used to transmit and/or receive data over a network environment. For example, the network interface 206 may include a device that can communicate with both inputs and outputs, for instance, a modulator/demodulator (e.g., a modem), wireless (e.g., radio frequency (RF)) transceiver, a telephonic interface, a bridge, a router, network card, etc.). The media management system 102 may communicate with one or more computing devices via the network interface 206 over the network 118 (FIG. 1A). The media management system 102 may further comprise mass storage 226. The peripheral interface 211 supports various interfaces including, but not limited to IEEE-1294 High Performance Serial Bus (Firewire), USB, a serial connection, and a parallel connection.

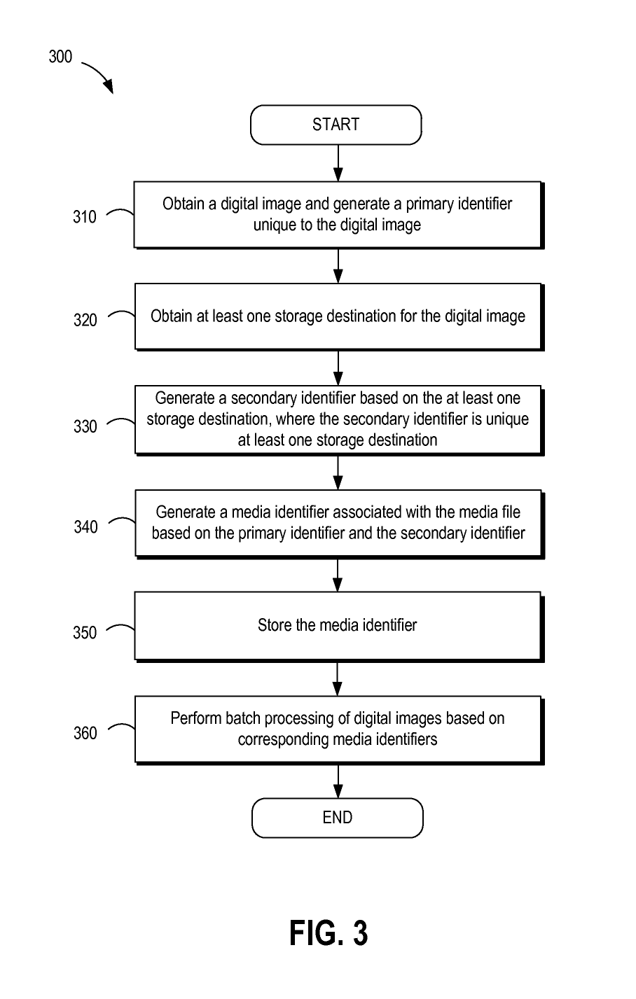

Reference is made to FIG. 3, which is a flowchart 300 in accordance with one embodiment for facilitating digital content management performed by the media management system 102 of FIG. 1A. It is understood that the flowchart 300 of FIG. 3 provides merely an example of the many different types of functional arrangements that may be employed to implement the operation of the various components of the media management system 102 (FIG. 1A). As an alternative, the flowchart of FIG. 3 may be viewed as depicting an example of steps of a method implemented in the media management system 102 according to one or more embodiments.

Although the flowchart of FIG. 3 shows a specific order of execution, it is understood that the order of execution may differ from that which is depicted. For example, the order of execution of two or more blocks may be scrambled relative to the order shown. Also, two or more blocks shown in succession in FIG. 3 may be executed concurrently or with partial concurrence. It is understood that all such variations are within the scope of the present disclosure.

Beginning with block 310, a digital image 115 (FIG. 1B) is imported via the media interface 112 (FIG. 1A). The primary ID generator 126 in the media ID generator 122 (FIG. 1B) generates a primary identifier 144 (FIG. 1B) unique to the media file.

In block 320, the user interface component 114 (FIG. 1A) obtains at least one storage destination 117a, 117b, 117c (FIG. 1B) for the digital image 115, where the storage destination 117a, 117b, 117c may correspond, for example, to an external hard drive, a smartphone, a tablet, a laptop, cloud storage, among any number of other storage devices/destinations. As described below, the at least one storage destination may be specified by the user or automatically determined by the analyzing component 113 (FIG. 1B) in the media interface 112 (FIG. 1B).

In block 330, a secondary identifier 146 (FIG. 1B) is generated based on the at least one storage destination 117a, 117b, 117c, where the second identifier is unique to the at least one storage destination. In block 340, the media ID generator 122 generates a media identifier associated with the media file based on the primary identifier and the secondary identifier.

In block 350, the media processor 116 stores the media identifier 142. For some embodiments, the media processor 116 may be configured to store the media identifier 142 locally in a database implemented in mass storage 226 (FIG. 2). For other embodiments, the media processor 116 may be configured to upload the media identifier 142 via a network 118 (FIG. 1B) to a database 154 (FIG. 1B) maintained by a media management server 152 (FIG. 1B).

In block 360, the batch processor 130 (FIG. 1B) performs batch processing of digital images 115 based on corresponding media identifiers 142. For example, the batch processor 130 may perform an image editing operation on all copies of a given digital image 115, regardless of whether the copies are distributed across various storage destinations 117a, 117b, 117c. The image editing operation may comprise any one or combination of operations including, but not limited to, a cropping operation, a rotation operation, image scaling/resizing, adjustment of brightness level, adjustment of sharpness level, color change, texture change, and so on.

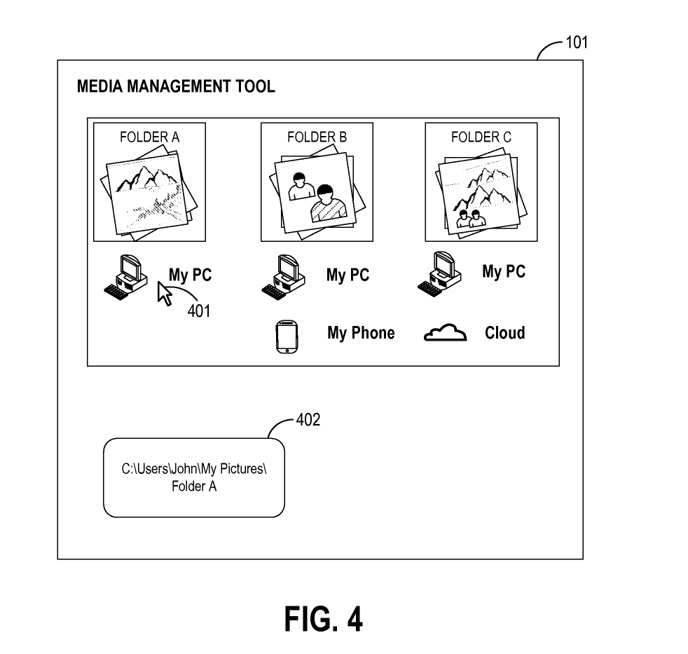

To further illustrate the digital content management techniques disclosed, reference is made to FIGS. 4-7, which illustrate the operation of the various components of the media management system 102 in accordance with various embodiments. With reference to FIG. 4, digital content management process begins with the media interface 112 (FIG. 1A) obtaining a digital image 115. As discussed earlier, the media interface 112 may retrieve the digital image 115 from various sources including a digital camera 107 (FIG. 1A), one or more media content sharing websites 134 (FIG. 1A) hosted on a server 137 (FIG. 1A), and so on.

In accordance with some embodiments, the user interface component 114 (FIG. 1B) generates and displays a user interface 101 to the user that allows the user to specify the storage destination for incoming digital images 115. For some embodiments, the analyzing component 113 (FIG. 1B) analyzes a designated database (for example, via a file path) of at least one of the computer systems and automatically determines one or more storage destinations for each media file in the designated database. Each storage destination corresponds to a storage device with computing capabilities or to a file path of a certain storage device.

For example, the analyzing component 113 may determine 10 photos in a first designated file path of the computer A (home), and 5 photos in a second designated file path of the computer B (tablet). Thus, the storage destinations of the 10 photos are marked as “computer A (home)” or “first designated file path” or both. For such embodiments, the user interface 101 may display the automatically determined storage destination(s) to the user (see e.g., FIG. 4). The storage devices for storing a digital image 115 may comprise a smartphone, a tablet, a personal computer, and/or cloud-based storage. Note that the user may store copies of the same digital image 115 in multiple locations.

FIG. 4 shows an example of a storage destination conveyed to the user in the form of a dialog box 402 where the storage destination (e.g., PC) was specified by the user or automatically determined by the analyzing component 113. In this regard, the analyzing component 113 may automatically determine a storage destination for a given digital image 115. As shown, “Folder A” is stored in the storage destination “My PC” while “Folder B” is stored in both “My PC” and “My Phone.” For some embodiments, when the user points to or hovers in close proximity to one of the storage destinations using, for example, a mouse 401, a dialog box 402 is displayed to the user and shows the file path associated with the storage destination.

The primary ID generator 126 (FIG. 1B) in the media ID generator 122 (FIG. 1B) generates a primary identifier 144 (FIG. 1B) based on at least one attribute of the digital image 115. Upon receiving user input specifying one or more storage locations for the digital image 115, the secondary ID generator 128 in the media ID generator 122 generates a secondary identifier 146 based on the specified storage destination. The media ID generator 122 then generates a media identifier 142 (FIG. 1B) based on the primary identifier 144 and the secondary identifier 146. Batch processing may then be performed by the batch processor 130 (FIG. 1B), as illustrated in the following figures.

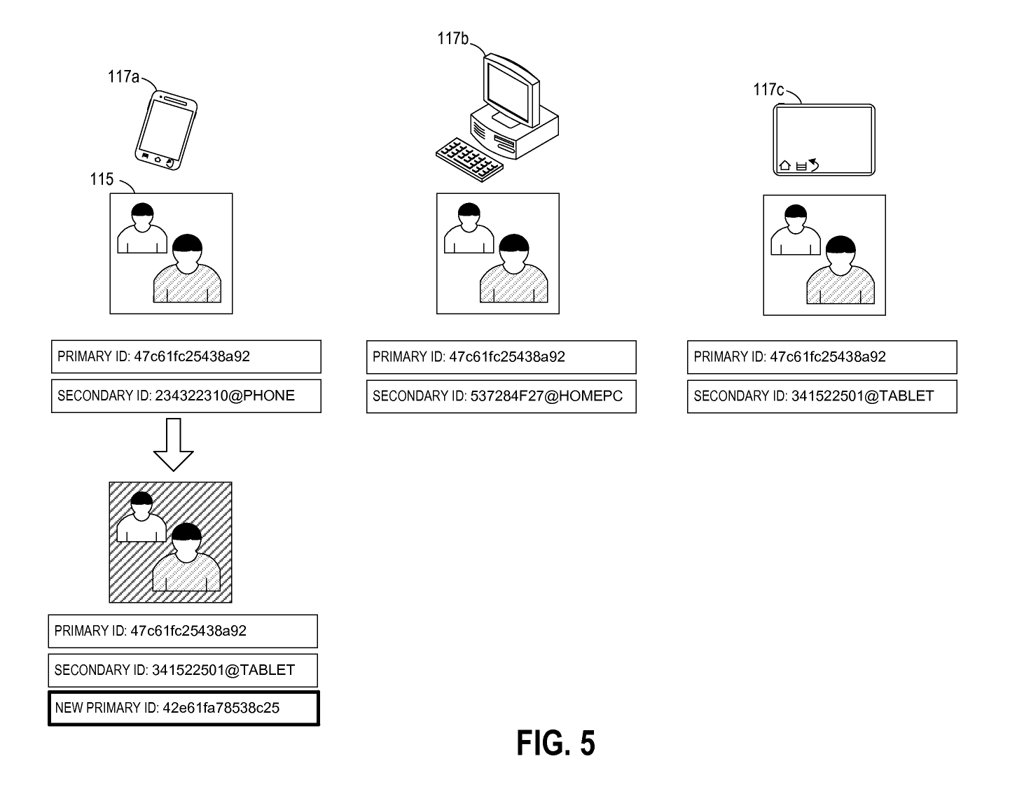

FIG. 5 illustrates an editing operation performed on a copy of a digital image 115 (FIG. 1A) that is applied to other copies of the same digital image 115. For purposes of illustration, assume that copies of the same digital image 115 are stored in the user's smartphone 117a, personal computer 117b, and tablet 117c. The user interface is rendered to display the different locations of the various storage destinations 117a, 117b, 117c for the same media file (digital image) 115. In the example shown, the user elects to modify a copy of the digital image 115 stored on the user's smartphone 117a by changing, for example, the contrast level of the digital image 115.

Upon receiving the user-specified modification, the media ID generator 122 (FIG. 1B) creates a new primary identifier based on at least one attribute of the modified digital image 115. Note that various embodiments, the first (original) primary identifier is not overwritten. Instead, the first primary identifier is maintained and a new media identifier is generated based on the new primary identifier and the media identifier 142. Note that the original primary identifier 144 (FIG. 1B) is preserved, and the new media identifier is associated with the original media identifier 142 (FIG. 1B).

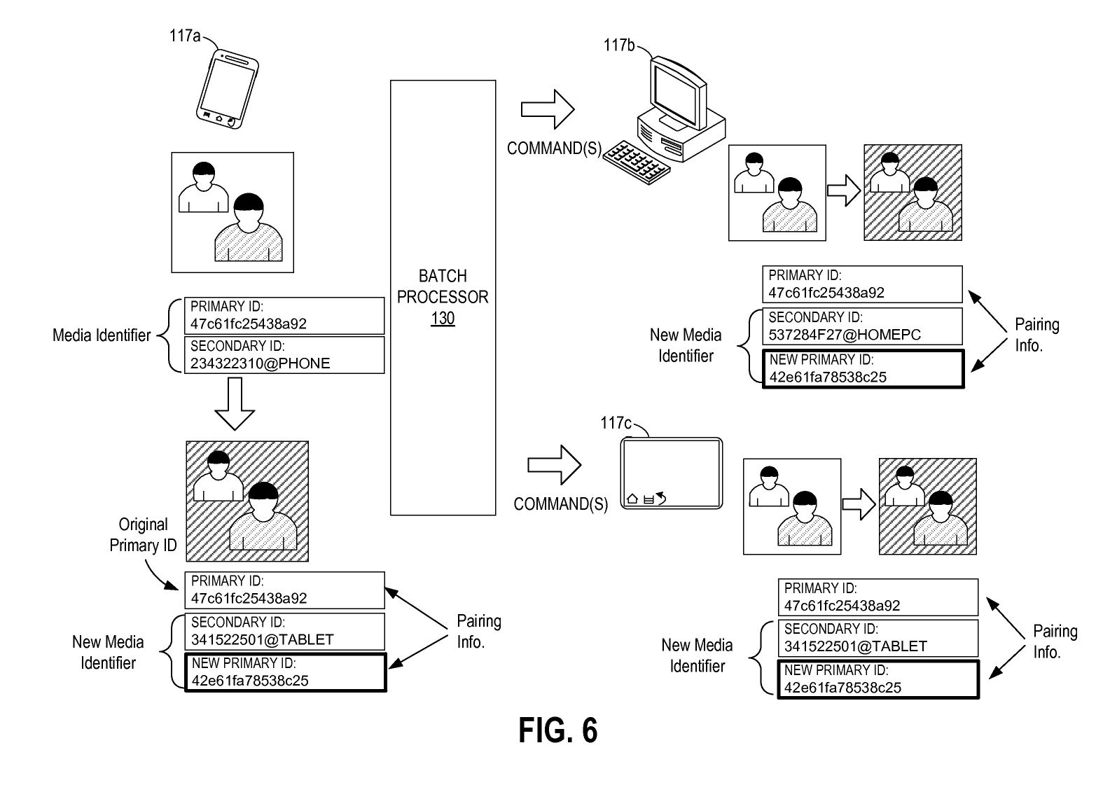

Turning now to FIG. 6, the batch processor 130 automatically applies the same modification (e.g., change in contrast level) to the other copies of the digital image 115 stored on the user's personal computer 117b and tablet 117c. In operation, the batch processor 130 identifies copies of the digital image 115 by retrieving media identifier 142 (FIG. 1B) information from the media management server 152 (FIG. 1B) corresponding to the digital image 115 and searches for digital images 115 that share the same primary identifier. Upon identifying the copies of the digital image 115, the batch processor 130 applies the same modification to the copies of the digital image. As illustrated in FIG. 5, a new primary identifier is created for each copy, and new media identifiers are generated. The original primary identifier and the new primary identifier are paired and stored together as pairing information.

In accordance with some embodiments, the batch processor 130 transmits commands corresponding to the batch processing to the media management server 152 (FIG. 1B). Then, when a media editing software or other software in one of the storage devices 117a, 117b, 117c (FIG. 1B) is activated, the commands are automatically downloaded to that storage device 117a, 117b, 117c where the commands are then executed on the media files sharing a common (original) primary identifier. When an image with an original primary identifier is deleted or overwritten by a processed image, only the new primary identifier of the processed image is available, and if user wishes to apply the same batch processing to other images with the same original primary identifier stored on different devices, the system can use the pairing information of both the original primary identifier and the new primary identifier to determine the original primary identifier. Based on this, other images with the same original primary identifier can be found on the different devices for purposes of applying the same batch processing operation.

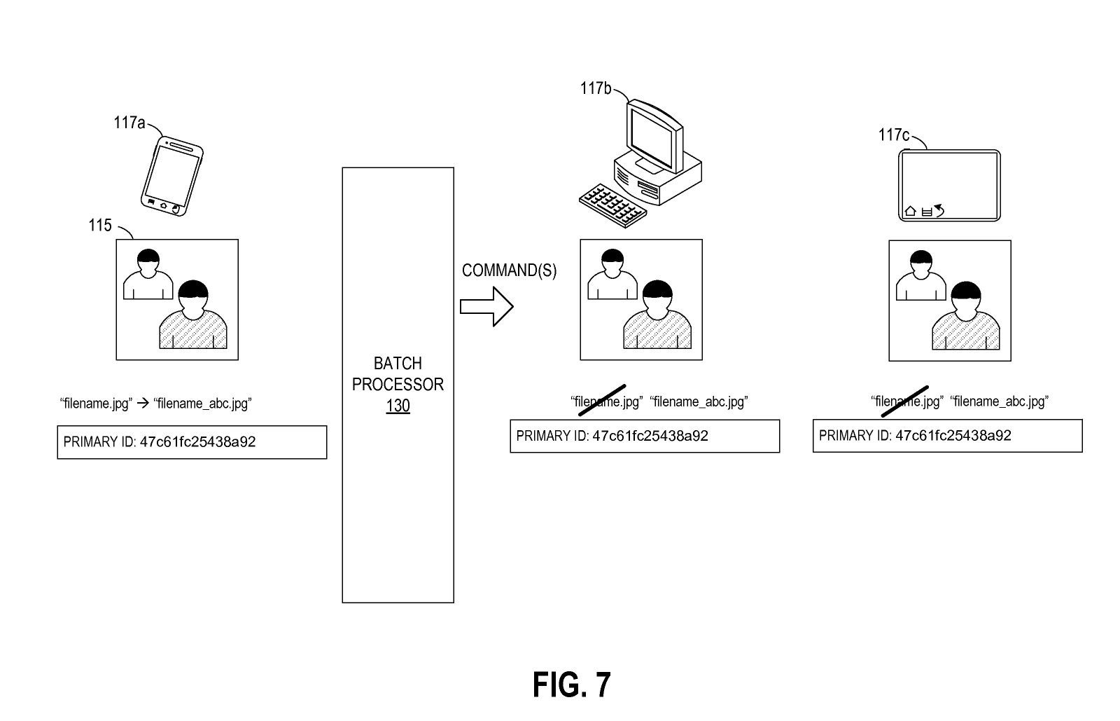

FIG. 7 illustrates a batch processing operation whereby the filename of the digital image 115 is renamed. As shown, the user elects to rename the filename of the copy of a digital image 115 from “filename.jpg” to “filename_abc.jpg.” In response to the modification to the filename, the batch processor 130 identifies copies of the digital image 115 by retrieving media identifier 142 (FIG. 1B) information from the media management server 152 (FIG. 1B) corresponding to the digital image 115 and searches for digital images 115 that share a common primary identifier. Upon identifying the copies of the digital image 115, the batch processor 130 applies the same modification (i.e., filename change) to the copies of the digital image. In some instances, the user may elect to delete duplicate media files. The batch processor 130 may be utilized to perform this operation. The batch processor 130 may also perform such functions as copying media files, pasting content into media files, moving media files, renaming media files, modifying attributes of media files, and so on.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

At least the following is claimed:

1. A method for managing digital content, comprising:
obtaining a media file and generating a primary identifier unique to the media file;
obtaining at least one storage destination for the media file, wherein the at least one storage destination comprises one of: at least one user-specified storage destination and at least one storage destination automatically determined by an analyzing component;
based on the at least one storage destination, generating a secondary identifier unique to the at least one storage destination;
generating a media identifier associated with the media file based on the primary identifier and the secondary identifier;
storing the media identifier; and
performing batch processing of media files based on corresponding media identifiers.

2. The method of claim 1, wherein the primary identifier is generated according to an MD5 (Message-Digest) algorithm.

3. The method of claim 1, wherein the primary identifier is generated according to one of CRC (cyclic redundancy check)-32 or CRC-64.

4. The method of claim 1, wherein the primary identifier is generated by analyzing at least one of color distribution and Exchangeable Image File Format (EXIF) data corresponding to content of the media file.

5. The method of claim 1, wherein performing batch processing of media files based on corresponding media identifiers comprises batch processing media files with media identifiers with a common primary identifier.

6. The method of claim 5, wherein batch processing comprises at least one media editing operation, wherein the at least one media editing operation comprises at least one of: a cropping operation, a rotation operation, image scaling, adjustment of brightness level, adjustment of sharpness level, color change, and texture change.

7. The method of claim 6, further comprising:
upon performing batch processing of media files based on corresponding media identifiers, generating a new primary identifier for the batch processed media files; and
generating new media identifiers based on the new primary identifier and the current media identifiers associated with the media files; and
storing the new media identifiers.

8. The method of claim 7, wherein the new media identifier is associated with the original media identifier.

9. The method of claim 6, wherein performing batch processing further comprises:
obtaining a user command via the user interface to delete duplicate media files; and
deleting media files according to the common primary identifier.

10. The method of claim 6, wherein performing batch processing further comprises one or more of:
copying media files;
pasting content into media files;
moving media files;
renaming media files; and
modifying attributes of media files.

11. The method of claim 5, wherein the media identifier is stored in a media management server.

12. The method of claim 11, wherein the media identifiers are transmitted to the media management server via a network.

13. The method of claim 11, wherein performing batch processing of media files based on corresponding media identifiers comprises:
transmitting commands corresponding to the batch processing to the media management server; and
transmitting, by the media management server, the commands to a storage device in response to an application initiating the batch processing on the storage device, wherein the commands are executed on media files with a common primary identifier.

14. The method of claim 13, wherein the application comprises a media editing application.

15. The method of claim 5, further comprising rendering for display a user interface presenting corresponding storage destinations of one of the media files according to the media identifier.

16. A system for managing digital content, comprising:
a media interface configured to obtain a media file;
an analyzing component configured to analyze at least one storage destination for the media file;
a media identifier (ID) generator configured to:
generate a primary identifier unique to the media file,
generate a secondary identifier unique to the at least one storage destination,
generate a media identifier associated with the media file based on the primary identifier and the secondary identifier, and
store the media identifier on a network storage device; and
a batch processor configured to perform batch processing of media files based on corresponding media identifiers.

17. The system of claim 16, wherein the batch processor performs batch processing according to an operation obtained from a user via a user interface rendered for display by the user interface component.

18. The system of claim 16, wherein the batch processor is configured to perform batch processing of media files by applying a common operation on media files with a common primary identifier.

19. The system of claim 18, wherein upon performing batch processing of media files, the media ID generator generates a new primary identifier for the batch processed media files and generates new media identifiers based on the new primary identifiers and the current media identifiers associated with the media files, wherein the media ID generator stores the new media identifiers on the network storage device.

20. The system of claim 16, wherein the network storage device comprises a media management server.

21. The system of claim 16, further comprising a user interface component configured to render for display a user interface presenting media files according to corresponding media identifiers.

22. The system of claim 21, wherein the user interface generated by the user interface component presents each media file and corresponding storage destinations in which the media file is stored.

23. The system of claim 22, wherein each storage destination corresponds to a storage device with computing capabilities.

24. The system of claim 23, wherein each of the storage device with computing capabilities comprises one of a desktop personal computer, a tablet, and a mobile phone.

25. A non-transitory computer-readable medium embodying a program executable in a computing device, comprising:
code that obtains a media file and generating a primary identifier unique to the media file based on at least one attribute of the media file;
code that obtains user input specifying at least one storage destination for the media file;
code that generates a secondary identifier based on the specified at least one storage destination;
code that generates a media identifier associated with the media file based on the primary identifier and the secondary identifier;
code that stores the media identifier in a network storage device;
code that renders for display a user interface presenting media files and corresponding storage destinations based on corresponding media identifiers;
code that obtains a command from a user relating to at least one media file presented on the user interface; and
code that applies the command to each copy of the media file stored in the corresponding storage destinations according to the corresponding media identifiers.

26. The non-transitory computer-readable medium of claim 25, further comprising:
code that generates a new primary identifier for each copy of the media file and updating the corresponding media identifiers upon application of the command to each copy of the media file; and
code that stores the new media identifiers to the network storage device.

27. The non-transitory computer-readable medium of claim 25, wherein the primary identifier is generated according to one of: an MD5 (Message-Digest) algorithm and a cyclic redundancy check (CRC) code.
